(19) United States
(12) Patent Application Publication
(10) Pub. No.: US 2014/0067400 A1
(43) Pub. Date: Mar. 6, 2014

(54) PHONETIC INFORMATION GENERATING DEVICE, VEHICLE-MOUNTED INFORMATION DEVICE, AND DATABASE GENERATION METHOD

(71) Applicant: Michihiro Yamazaki, Tokyo (JP)

(72) Inventor: Michihiro Yamazaki, Tokyo (JP)

(73) Assignee: MITSUBISHI ELECTRIC CORPORATION, Tokyo (JP)

(21) Appl. No.: 14/009,300

(22) PCT Filed: Jun. 14, 2011
(86) PCT No.: PCT/JP11/03374

§ 371 Date: Oct. 1, 2013

(51) Int. Cl. G10L 13/08

(52) U.S. Cl. CPC G10L 13/08
USPC 704/260

(57) ABSTRACT

In a word string information DB, when phonetic information automatically generated from written notation information matches regular phonetic information, only the written notation information is registered, or, when the phonetic information automatically generated does not match the regular phonetic information, the written notation information and the regular phonetic information are registered. A word string information retrieving unit 2 retrieves information of a word string matching an input character string from the word string information DB, and, when regular phonetic information is not registered for the word string, a phonetic information generation determining unit 3 causes a phonetic information generating unit 4 to generate phonetic information and output this phonetic information to outside a phonetic information generating device, or, when the regular phonetic information is registered for the word string, outputs the regular phonetic information to outside the phonetic information generating device from a phonetic information output unit 5.

### FIELD OF THE INVENTION

The present invention relates to a phonetic information generating device that generates phonetic information of a word string or a word, a vehicle-mounted information device that carries out a voice synthesis or voice recognition process by using this phonetic information generating device, and a generation method for generating a word string information database which this phonetic information generating device requires to generate phonetic information.

### BACKGROUND OF THE INVENTION

Currently, a voice input/output interface is commonly used in car navigation devices, and a voice synthesis function of producing an audio output of a place name, such as a city name or a road name and a function of carrying out voice recognition on a place name uttered by the user are required of car navigation devices. In order to carry out voice synthesis and voice recognition, car navigation devices require phonetic information showing a reading of a word, such as a place name, which is the target for voice synthesis and voice recognition. Therefore, a conventional voice synthesizer has a database for storing written notation information showing the written notation (or the graphemic representation) of each word, and phonetic information corresponding to the written notation (for example, refer to patent references 1 and 2).

On the other hand, there is a technology of generating phonetic information corresponding to the written notation of a word, such as grapheme-to-phoneme (G2P or GTP) conversion. For example, when G2P conversion is carried out on the written notation “ALDER BEND” of a city in New York State, “*″Ol|d@r″bEnd” is generated as phonetic information.

### RELATED ART DOCUMENT

### Patent Reference

Patent reference 1: Japanese Unexamined Patent Application Publication No. Hei 9-325789
Patent reference 2: Japanese Unexamined Patent Application Publication No. 2004-326367

### SUMMARY OF THE INVENTION

### Problems to be Solved by the Invention

Because conventional voice synthesizers are constructed in such a way as to store phonetic information corresponding to the written notation of each word in a database, the size of the database is very large. Therefore, a problem is that a large-volume memory for storing the database is required.

On the other hand, because the conventional structure of generating phonetic information corresponding to a written notation by using a technology, such as G2P conversion, has only to store only written notation information in a database and generate phonetic information as needed, the size of the database can be reduced. A problem is, however, that generated phonetic information is not necessarily correct. For example, although the correct phonetic information of the written notation “ALDER BROOK” of a city in New York State is “*″Ol|d@r″brUk”, the use of G2P conversion results in generation of incorrect phonetic “*″Ol|d@r ″krik.”

The present invention is made in order to solve the above-mentioned problems, and it is therefore an object of the present invention to generate correct phonetic information corresponding to a written notation by using a database having a small capacity.

### Means for Solving the Problem

A phonetic information generating device according to the present invention includes: a word string/word information database in which when phonetic information automatically generated from written notation information of a word string or a word does not match regular phonetic information corresponding to the written notation of the word string or the word, the regular phonetic information is registered together with the written notation information, or, when the phonetic information automatically generated matches the regular phonetic information, the written notation information is registered, but the regular phonetic information is not registered; a word string information retriever that retrieves written notation information corresponding to an inputted word string or word from the word string/word information database; a phonetic information generation determinator that determines whether or not regular phonetic information corresponding to the written notation information which the word string information retriever retrieves is registered in the word string/word information database; a phonetic information generator that generates phonetic information from the written notation information for which no regular phonetic information is registered according to the result of the determination by the phonetic information generation determinator; and a phonetic information output unit that, when regular phonetic information is not registered for the written notation information according to the result of the determination by the phonetic information generation determinator, outputs the phonetic information generated by the phonetic information generator, or, when the regular phonetic information is registered, outputs the regular phonetic information registered in the word string/word information database.

Further, a vehicle-mounted information device according to the present invention includes: the above-mentioned phonetic information generating device; and at least one of a voice synthesizer that generates phonetic information of a word string or a word whose sound is to be outputted by using the phonetic information generating device, and for converting the generated phonetic information into a synthesized voice, and a voice recognizer that generates a voice recognition dictionary on the basis of phonetic information which the phonetic information generating device generates from an input character string including a word string or a word which is a target for voice recognition, and for carrying out voice recognition on voice information inputted thereto by using the voice recognition dictionary.

In addition, a database generation method according to the present invention includes: a phonetic information generating step of generating phonetic information from written notation information of a word string or a word on the basis of input data including the written notation information and regular phonetic information corresponding to the written notation of the word string or the word; a phonetic information comparing step of comparing the phonetic information generated in the phonetic information generating step with the regular phonetic information included in the input data; a word string information registering step of registering the regular phonetic information in a database together with the written notation information when the phonetic information generated in the phonetic information generating step does not match the regular phonetic information according to the result of the comparison in the phonetic information comparing step, or, when the phonetic information generated matches the regular phonetic information, registering the written notation information in the database, but not registering the regular phonetic information.

### Advantages of the Invention

According to the present invention, because when it has been clear that phonetic information automatically generated matches regular phonetic information, the phonetic information generating device generates the phonetic information from notation information in the phonetic information generating process, the phonetic information generating device does not have to register the regular phonetic information in the database, and can reduce the size of the database. In contrast, because when it has been clear that the phonetic information generated automatically does not match the regular phonetic information, the phonetic information generating device registers the regular phonetic information in the database, and uses the phonetic information registered in the database without generating phonetic information from the notation information in the phonetic information generating process. Therefore, the phonetic information generating device can prevent the generation of incorrect phonetic information. As a result, the phonetic information generating device can generate correct phonetic information corresponding to a written notation by using the database having a small capacity.

Further, because the size of the database is reduced according to the present invention, the phonetic information generating device can be downsized and can be made to be suitable for use in a vehicle-mounted information device which needs to be downsized.

### BRIEF DESCRIPTION OF THE FIGURES

FIG. 1 is a block diagram showing the structure of a phonetic information generating device according to Embodiment 1 of the present invention;

FIG. 2 is a diagram showing an example of a word string information DB which the phonetic information generating device in accordance with Embodiment 1 has;

FIG. 3 is a diagram showing another example of the word string information DB which the phonetic information generating device in accordance with Embodiment 1 has;

FIG. 4 is a flow chart showing the operation of the phonetic information generating device in accordance with Embodiment 1;

FIG. 5 is a block diagram showing the structure of a DB generating device in accordance with Embodiment 1;

FIG. 6 is a flow chart showing the operation of DB generating device in accordance with Embodiment 1;

FIG. 7 is a flow chart showing the structure of a DB generating device in accordance with Embodiment 2 of the present invention;

FIG. 8 is a diagram showing an example of a word string information DB which the DB generating device in accordance with Embodiment 2 generates;

FIG. 9 is a flow chart showing the operation of the DB generating device in accordance with Embodiment 2;

FIG. 10 is a diagram showing an example of a word string information DB and a phonetic information list which a phonetic information generating device in accordance with Embodiment 3 of the present invention has;

FIG. 11 is a flow chart showing the operation of the phonetic information generating device in accordance with Embodiment 3;

FIG. 12 is a diagram showing another example of the word string information DB and the phonetic information list which the phonetic information generating device in accordance with Embodiment 3 has;

FIG. 13 is a diagram showing an example of a word string information DB and a phonetic information list which a DB generating device in accordance with Embodiment 4 of the present invention generates; and

FIG. 14 is a block diagram showing the structure of a navigation device according to Embodiment 5 of the present invention.

### EMBODIMENTS OF THE INVENTION

Hereafter, in order to explain this invention in greater detail, the preferred embodiments of the present invention will be described with reference to the accompanying drawings. Embodiment 1.

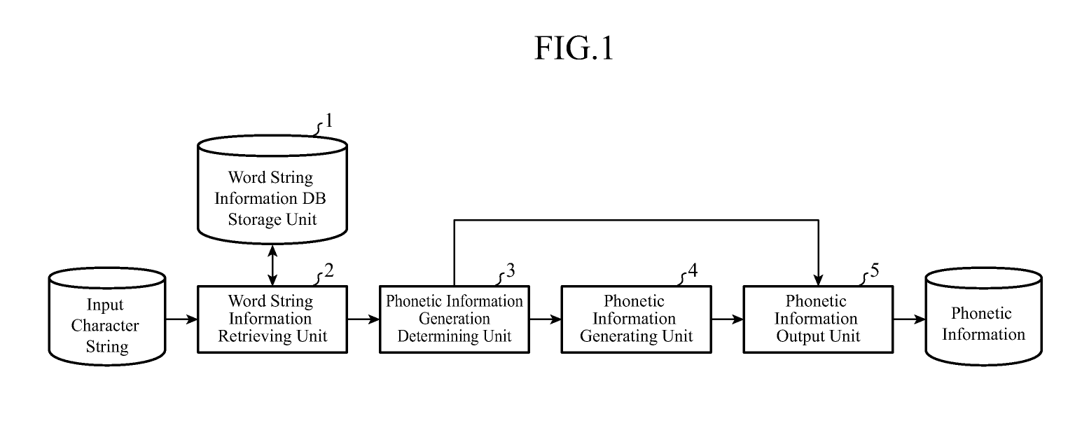

A phonetic information generating device shown in FIG. 1 uses a character string as its input, and generates phonetic information corresponding to the inputted character string, and is comprised of a word string information database (referred to as a DB from here on) storage unit 1, a word string information retrieving unit 2, a phonetic information generation determining unit 3, a phonetic information generating unit 4, and a phonetic information output unit 5.

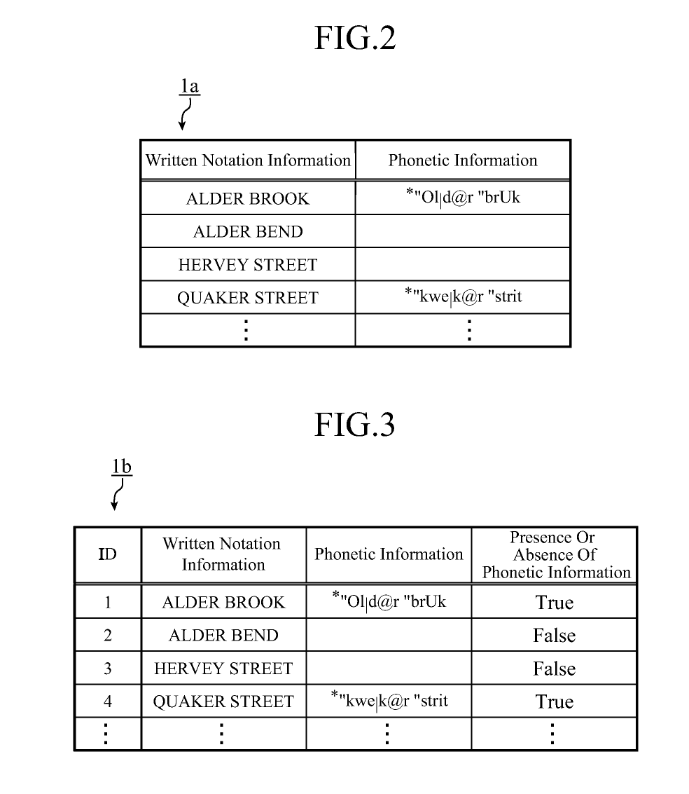

The word string information DB storage unit 1 stores a DB (referred to as a word string information DB 1a from here on) in which written notation information showing the written notation of a word string and phonetic information showing a regular sound of this written notation with characters and symbols are registered as word string information while the written notation information and the phonetic information are being combined as a set. FIG. 2 is a diagram showing an example of the word string information DB 1a. When phonetic information automatically generated from the written notation information of a word string by using G2P conversion or the like does not match phonetic information (referred to as regular phonetic information from here) which is acquired from a man-maintained DB, such as a pronunciation dictionary or a map DB, the regular phonetic information is registered in the word string information DB together with the written notation information as a set. In contrast, when phonetic information automatically generated from the written notation information of a word string by using G2P conversion or the like matches the regular phonetic information of the word string, only the written notation information is registered in the word string information DB 1a. A method of generating the word string information DB 1a will be mentioned below.

For example, while the regular phonetic information corresponding to the written notation “ALDER BROOK” of a city in New York State is “*″Ol|d@r ″brUk,” the phonetic information result for the word string which is automatically generated by using G2P conversion or the like is “*″Ol|d@r ″krik.” In this case, the regular phonetic information “*″Ol|d@r ″brUk” is registered as phonetic information that is combined as a set with the written notation information “ALDER BROOK.” In contrast, while the regular phonetic information corresponding to the written notation “ALDER BEND” of a city in New York State is “*″Ol|d@r ″bEnd,” the phonetic information result for the word string which is automatically generated by using G2P conversion or the like is also “*″Ol|d@r ″bEnd.” In this case, because the regular phonetic information can be acquired through the automatic generation, nothing is registered as phonetic information that is combined as a set with the written notation information “ALDER BEND.”

Further, for example, because regular phonetic information can be acquired from the written notation information “HERVEY STREET” through the automatic generation, no phonetic information corresponding to the written notation information is registered in the word string information DB 1a. In contrast, because regular phonetic information cannot be acquired from the written notation information “QUAKER STREET” through the automatic generation, the regular phonetic information “*″kwe|k@r ″strit” is registered in the word string information DB 1a. For convenience of explanation, whether regular phonetic information can be automatically generated by using G2P conversion or the like is determined presumptively for each word string shown above as an example, it is needless to say that there is a case in which phonetic information automatically generated from written notation information differs from phonetic information automatically generated by using actual G2P conversion.

A word string registered in the word string information DB 1a is not limited to such a place name as mentioned above, and can be a word string according to the intended purpose of the phonetic information, such as an address name, a facility name, a person's name, or a company name.

The word string information retrieving unit 2 uses the inputted character string, which is a target for generation of phonetic information, as a search key, and searches through the word string information DB 1a in the word string information DB storage unit 1 to retrieve word string information having information matching this search key. It is assumed hereafter that this inputted character string is the written notation information of a word string (e.g., “ALDER BROOK”).

The phonetic information generation determining unit 3 checks to see whether or not regular phonetic information is stored in the word string information retrieved by the word string information retrieving unit 2 to determine whether or not to automatically generate phonetic information by using the phonetic information generating unit 4 which is a stage located behind the phonetic information generation determining unit. When determining that it is necessary to automatically generate phonetic information, the phonetic information generating device outputs the corresponding word string information from the phonetic information generation determining unit 3 to the phonetic information generating unit 4. In contrast, when determining that it is not necessary to automatically generate phonetic information, the phonetic information generating device outputs the corresponding word string information from the phonetic information generation determining unit 3 to the phonetic information output unit 5.

When the phonetic information generation determining unit 3 determines that it is necessary to automatically generate phonetic information, the phonetic information generating unit 4 receives the word string information from the phonetic information generation determining unit 3, and automatically generates phonetic information corresponding to the written notation information of the word string by using a predetermined method, such as G2P conversion.

When the phonetic information generation determining unit 3 determines that it is necessary to automatically generate phonetic information, the phonetic information output unit 5 receives the phonetic information which the phonetic information generating unit 4 generates automatically and outputs the phonetic information to outside the phonetic information generating device. In contrast, when the phonetic information generation determining unit determines that it is not necessary to automatically generate phonetic information, the phonetic information output unit receives the regular phonetic information registered in the word string information DB 1a via the word string information retrieving unit 2 and the phonetic information generation determining unit 3, and outputs the regular phonetic information to outside the phonetic information generating device.

The word string information DB storage unit 1 can store a word string information DB 1b as shown in FIG. 3, instead of the word string information DB 1a as shown in FIG. 2. As shown in FIG. 3, in the word string information DB 1b, for each word string, in addition to written notation information and phonetic information, identification information (referred to as an ID from here on) specific to the word string and a flag (True or False) showing the presence or absence of phonetic information are registered as word string information while being combined as a set with the written notation information and the phonetic information. In the case in which the word string information DB storage unit stores the word string information DB 1b, an input character string inputted to the word string information retrieving unit 2 can be the written notation information of a word string (e.g., “ALDER BROOK”) or an ID specific to a word string (e.g., “1”). The word string information retrieving unit 2 can change the range in the word string information DB 1b through which the word string information retrieving unit searches according to the type of the inputted character string (whether the inputted character string is written notation information or an ID).

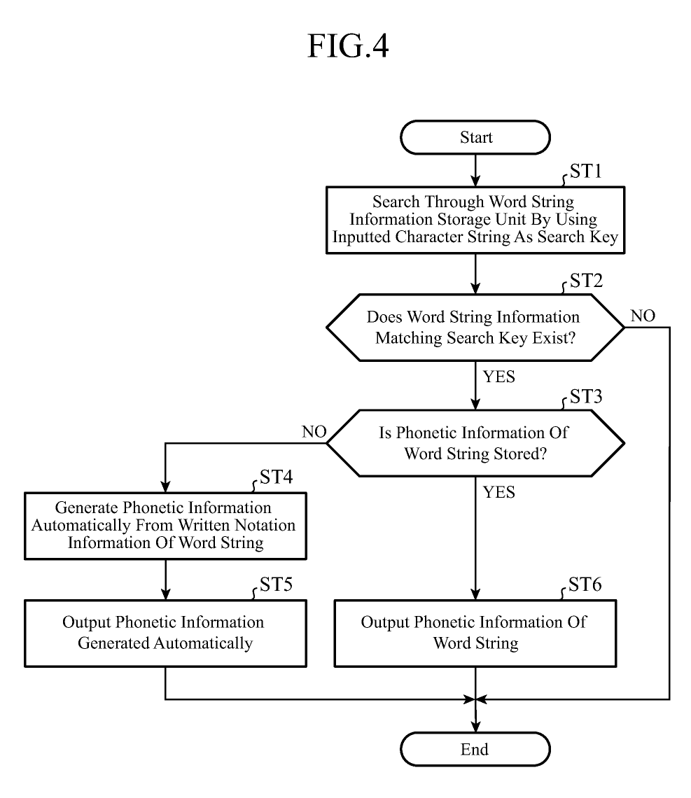

Next, the operation of the phonetic information generating device will be explained by using a flow chart shown in FIG. 4. First, when an input character string which is a candidate for generation of phonetic information is inputted to the word string information retrieving unit 2, the word string information retrieving unit 2, in step ST1, uses this input character string as a search key to search through the word string information DB 1a to retrieve word string information matching the search key.

When, in next step ST2, not finding word string information matching the search key (when “NO” in step ST2), the word string information retrieving unit 2 ends a series of phonetic information generating processes. At that time, a certain unit, e.g., the phonetic information output unit 5 can produce an external output showing that the word string is not registered in the word string information DB 1a. In contrast, when finding word string information matching the search key (when “YES” in step ST2), the word string information retrieving unit 2 retrieves the word string information, and then advances to next step ST3. For example, in a case in which the word string information DB storage unit 1 has a configuration of storing either the word string information DB 1a shown in FIG. 2 or the word string information DB 1b shown in FIG. 3, when the input character string “ALDER BROOK” is inputted, the word string information retrieving unit 2 uses this input character string as a search key for written notation information, and retrieves the word string information including the written notation information “ALDER BROOK” and the phonetic information “*″Ol|d@r ″brUk” which is combined as a set with the written notation information from the word string information DB 1a or 1b.

As an alternative, in a case in which the word string information DB storage unit 1 has a configuration of storing the word string information DB 1b shown in FIG. 3, when “1” is inputted as the input character string, the word string information retrieving unit 2 uses this input character string as a search key for ID, and retrieves the word string information including the ID of “1”, and the written notation information “ALDER BROOK”, the phonetic information “*″Ol|d@r ″brUk,” and the flag of “Ture” which are combined as a set with the ID from the word string information DB 1b shown in FIG. 3.

The phonetic information generation determining unit 3, in next step ST3, checks whether or not phonetic information is included in the word string information inputted thereto from the word string information retrieving unit 2, and, when phonetic information is included in the word string information (when “YES” in step ST3), determines that the phonetic information generating unit 4 does not have to automatically generate phonetic information of the word string, and then advances to step ST6, whereas when phonetic information is not included in the word string information (when “NO” in step ST3), the phonetic information generation determining unit determines that the phonetic information generating unit 4 needs to automatically generate phonetic information of the word string, and then advances to step ST4. When a flag showing the presence or absence of phonetic information is included in the word string information, the phonetic information generation determining unit 3 can check the flag to determine whether or not there is a necessity to automatically generate phonetic information.

When the phonetic information generation determining unit 3 determines that the phonetic information generating unit needs to automatically generate phonetic information of the word string (when “NO” in step ST3), the phonetic information generating unit 4, in next step ST4, generates phonetic information of the word string from the display information included in the word string information retrieved by the word string information retrieving unit 2 by using G2P conversion or the like, and outputs the phonetic information to the phonetic information output unit 5. The phonetic information output unit 5 then, in next step ST5, outputs the phonetic information automatically generated by the phonetic information generating unit 4 to outside the phonetic information generating device. In contrast, when the phonetic information generation determining unit 3 determines that the phonetic information generating unit does not have to automatically generate phonetic information of the word string (when “YES” in step ST3), the phonetic information output unit 5, in next step ST6, outputs the phonetic information included in the word string information retrieved by the word string information retrieving unit 2 to outside the phonetic information generating device. As an alternative, the phonetic information output unit 5 can have a structure of, when the phonetic information generation determining unit determines that the phonetic information generating unit does not have to automatically generate phonetic information of the word string, retrieving the phonetic information from the word string information DB 1a.

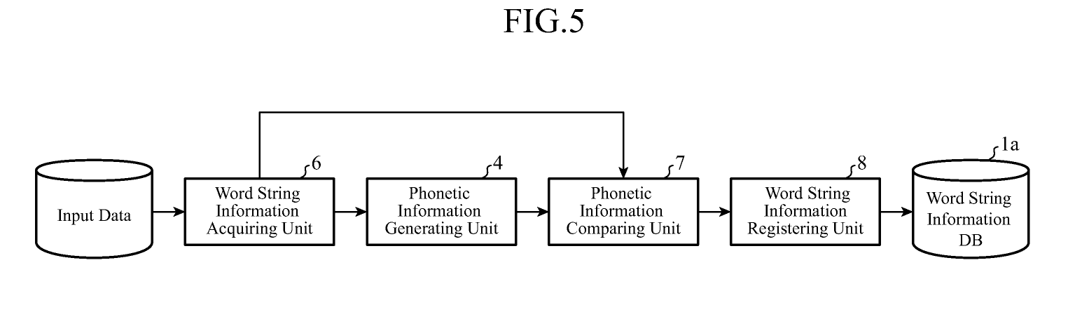

Next, a method of generating the word string information DB 1a which is stored in the word string information DB storage unit 1 will be explained. FIG. 5 is a block diagram showing the structure of a DB generating device for generating the word string information DB 1a. The DB generating device shown in FIG. 5 generates the word string information DB 1a in which word string information included in input data is registered, and is comprised of a word string information acquiring unit 6, a phonetic information generating unit 4, a phonetic information comparing unit 7, and a word string information registering unit 8. It is assumed that a method of generating phonetic information which the phonetic information generating unit 4 included in the DB generating device uses is the same as the method (G2P conversion) which the phonetic information generating unit 4 included in the phonetic information generating device uses. Further, input data inputted to the DB generating device can be word string information which is a set of written notation information showing a place name or the like which is included in a map DB, and regular phonetic information in a case in which the phonetic information generating device shown in FIG. 1 is applied to a navigation device.

The word string information acquiring unit 6 acquires yet-to-be-processed word string information from the input data. The phonetic information generating unit 4 automatically generates phonetic information from the written notation information included in the word string information acquired by the word string information acquiring unit 6 by using the predetermined method, such as G2P conversion. The phonetic information comparing unit 7 compares the regular phonetic information included in the word string information acquired by the word string information acquiring unit 6 with the phonetic information automatically generated by the phonetic information generating unit 4 to determine whether they match each other. When the phonetic information generating unit 4 determines that the regular phonetic information matches the phonetic information automatically generated by the phonetic information generating unit, the word string information registering unit 8 registers only the written notation information included in the word string information in the word string information DB 1a, but does not register the phonetic information in the word string information DB. In contrast, when the phonetic information generating unit determines that the regular phonetic information does not match the phonetic information automatically generated by the phonetic information generating unit, the word string information registering unit registers the written notation information and the regular phonetic information, which are included in the word string information in the input data which the word string information registering unit receives via the word string information acquiring unit 6, the phonetic information generating unit 4, and the phonetic information comparing unit 7, in the word string information DB 1a while combining the written notation information and the regular phonetic information as a set. As a result, a DB in which such pieces of word string information as shown in FIG. 2 are registered is generated as the word string information DB 1a.

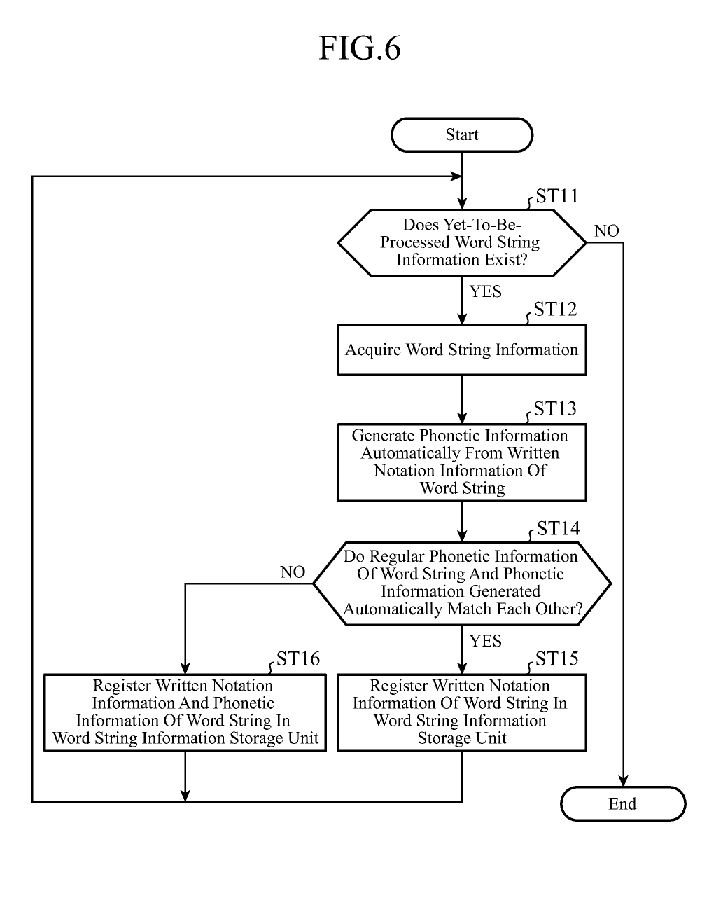

Next, the operation of the DB generating device will be explained by using a flow chart shown in FIG. 6. When input data which is a target to be registered in the word string information DB 1a is first inputted to the word string information acquiring unit 6 in step ST11, and yet-to-be-processed word string information exists in the input data (when “YES” in step ST11), the word string information acquiring unit acquires the word string information and outputs the word string information to the phonetic information generating unit 4 and the phonetic information comparing unit (step ST12). In contrast, when yet-to-be-processed word string information does not exist in the input data (when “NO” in step ST11), the word string information acquiring unit ends the DB generating process.

The phonetic information generating unit 4, in step ST13, automatically generates phonetic information of the word string from the written notation information included in the word string information acquired by the word string information acquiring unit 6 by using G2P conversion or the like, and outputs the phonetic information to the phonetic information comparing unit 7. The phonetic information comparing unit 7 then, in next step ST14, compares the phonetic information automatically generated by the phonetic information generating unit 4 with the regular phonetic information included in the word string information of the same word string acquired by the word string information acquiring unit 6, and determines whether they match each other and outputs the result of the determination to the word string information registering unit 8. When the word string consists of a plurality of words, the phonetic information comparing unit 7 determines that the phonetic information automatically generated by the phonetic information generating unit matches the regular phonetic information included in the word string information of the same word string acquired by the word string information acquiring unit only when the automatically-generated phonetic information of each of all the words matches with the corresponding regular phonetic information, For example, when the phonetic information acquired from the input data is “*″Ol|d@r ″brUk” and the phonetic information generated automatically is “*″Ol|d@r ″krik” for the written notation information “ALDER BROOK,” the phonetic information comparing unit 7 determines that the phonetic information automatically generated by the phonetic information generating unit does not match the regular phonetic information included in the word string information of the same word string acquired by the word string information acquiring unit in full throughout the whole word string because the phonetic information of the word “ALDER” acquired from the input data matches the phonetic information automatically generated of the word “ALDER” while the phonetic information of the word “BROOK” acquired from the input data does not match the phonetic information automatically generated of the word “BROOK.”

When the phonetic information comparing unit 7 determines that the phonetic information automatically generated by the phonetic information generating unit matches the regular phonetic information included in the word string information of the same word string acquired by the word string information acquiring unit (when “YES” in step ST14), the word string information registering unit 8, in next step ST15, registers the written notation information included in the word string information acquired by the word string information acquiring unit 6 in the word string information DB 1a, but does not register any phonetic information in the word string information DB. In contrast, when the phonetic information comparing unit 7 determines that the phonetic information automatically generated by the phonetic information generating unit does not match the regular phonetic information included in the word string information of the same word string acquired by the word string information acquiring unit (when “NO” in step ST14), the word string information registering unit 8, in next step ST16, registers the written notation information of the word string information acquired by the word string information acquiring unit 6 and the regular phonetic information in the word string information DB 1a while combining the written notation information and the regular phonetic information as a set.

When completing the processes of up to step ST15 or ST16 on the word string information which is the target to be registered, the DB generating device returns to step ST11 again and starts the processing on the next word string information of the input data.

The DB generated by the DB generating device can have a configuration like that of the word string information DB 1b shown in FIG. 3, instead of that of the word string information DB 1a shown in FIG. 2. In this case, when, in step ST16 of FIG. 6, registering word string information in the word string information DB 1a, the word string information registering unit 8 also registers an ID specific to this word string and a flag showing the presence or absence of phonetic information for this word string.

As mentioned above, the phonetic information generating device according to Embodiment 1 is constructed in such a way as to include: the word string information DB storage unit 1 for storing the word string information DB 1a in which when phonetic information automatically generated from written notation information of a word string by using a predetermined method, such as G2P conversion, does not match regular phonetic information corresponding to the written notation of the word string, the regular phonetic information is registered together with the written notation information, or, when the phonetic information automatically generated matches the regular phonetic information, only the written notation information is registered; the word string information retrieving unit 2 for retrieving word string information including written notation information corresponding to an inputted word string from the word string information DB 1a; the phonetic information generation determining unit 3 for determining whether or not regular phonetic information corresponding to the written notation information which the word string information retrieving unit 2 retrieves and regular phonetic information corresponding to the written notation information which is retrieved from the word string information DB 1a are registered in the word string information DB 1a; the phonetic information generating unit 4 for generating phonetic information from the written notation information for which no regular phonetic information is registered according to the result of the determination by the phonetic information generation determining unit 3 by using a predetermined method, such as G2P conversion; and the phonetic information output unit 5 for, when regular phonetic information corresponding to the written notation information is not registered according to the result of the determination by the phonetic information generation determining unit 3, outputting the phonetic information generated by the phonetic information generating unit 4, or, when the regular phonetic information corresponding to the written notation information is registered, outputting the regular phonetic information registered in the word string information DB 1a. Therefore, when it has been clear that the phonetic information automatically generated from the written notation information of a word string matches the regular phonetic information of this word string, the phonetic information generating device does not have to register the phonetic information in the word string information DB 1a. The phonetic information generating device can thus reduce the capacity of the word string information DB 1a. In contrast, when it has been clear that the phonetic information automatically generated from the written notation information of a word string does not match the regular phonetic information of this word string, the phonetic information generating device stores the regular phonetic information in the word string information DB 1a, and uses the regular phonetic information stored in the word string information DB 1a without carrying out the automatic generation while carrying out the phonetic information generating process. Therefore, the phonetic information generating device can prevent from incorrect phonetic information from being generated. Therefore, the phonetic information generating device can generate correct phonetic information by using the database having a small capacity.

Although the DB generating device has a structure of registering written notation information and phonetic information on a per word string basis (for each word string such as “ALDER BROOK”) in the word string information DB 1a or 1b in above-mentioned Embodiment 1, this embodiment is not limited to this structure. For example, the DB generating device can have a structure of registering written notation information and phonetic information on a per word basis (for each word such as “ALDER”) (i.e., registering written notation information and phonetic information in a word information DB). In a case in which the word string information DB 1a or 1b in which written notation information and phonetic information are registered on a per word basis is stored in the word string information DB storage unit 1 in the phonetic information generating device, the word string information retrieving unit 2, the phonetic information generation determining unit 3, the phonetic information generating unit 4, and the phonetic information output unit 5 have only to carry out their processes on a per word basis. Further, although a word string consisting of two words is shown in the illustrated example, a word string consisting of three or more words can be alternatively processed, or a word, instead of a word string, can be alternatively processed.

In a case in which the phonetic information generating device is constructed of a computer, a program in which the processes of the word string information DB 1a, the word string information retrieving unit 2, the phonetic information generation determining unit 3, the phonetic information generating unit 4, and the phonetic information output unit 5 are described can be stored in a memory of the computer, and a CPU of the computer can be constructed in such a way as to execute the program stored in the memory. In a case in which the DB generating device is similarly constructed of a computer, a program in which the processes of the phonetic information generating unit 4, the word string information acquiring unit 6, the phonetic information comparing unit 7, and the word string information registering unit 8 are described is stored in a memory of the computer, and a CPU of the computer can be constructed in such a way as to execute the program stored in the memory.

### Embodiment 2

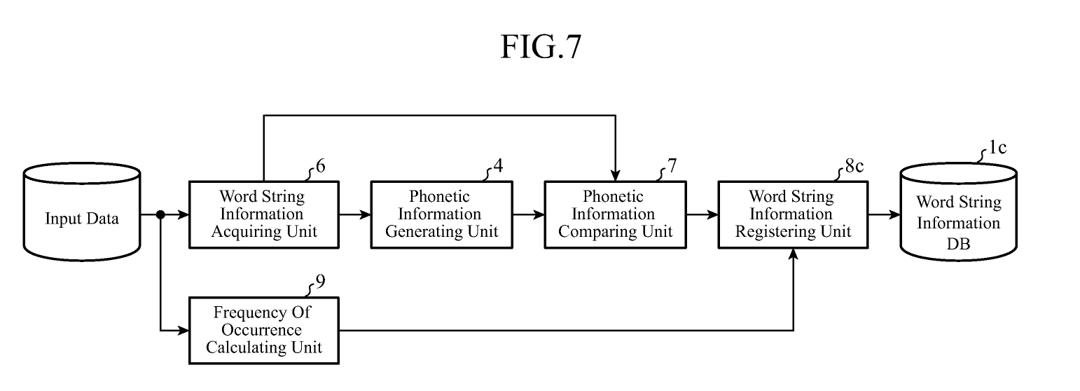

FIG. 7 is a block diagram showing the structure of a DB generating device in accordance with this Embodiment 2. This DB generating device is newly provided with a frequency of occurrence calculating unit 9 for calculating the frequency of occurrence of a word string in a word string information DB, and is constructed in such a way that a word string information registering unit 8 determines whether or not to register a word string according to the frequency of occurrence of the word string, and the DB generating device generates a word string information DB 1c which takes the frequency of occurrence into consideration. In addition, the same components as those shown in FIG. 5 or like components are designated by the same reference numerals in FIG. 7, and the explanation of the components will be omitted hereafter. Further, because a phonetic information generating device that uses the word string information DB 1c which the DB generating device in accordance with this Embodiment 2 generates has the same structure as the phonetic information generating device shown in FIG. 1, the structure of the phonetic information generating device is as shown in FIG. 1.

Although regular phonetic information is not registered in the word string information DB 1a or 1b when phonetic information automatically generated by the phonetic information generating unit 4 matches the regular phonetic information in above-mentioned Embodiment 1, even when phonetic information of a word string which is automatically generated by a phonetic information generating unit matches regular phonetic information, the phonetic information generating device registers the regular phonetic information in the word string information DB 1c when the frequency of occurrence of the word string is equal to or higher than a specified threshold in this Embodiment 2. Although the frequency of occurrence mentioned above is the one of the word string in the word string information DB 1c, because the frequency of occurrence of the word string is unknown while the DB is being generated, the frequency of occurrence of the word string in data which is a source for generating the word string information DB, i.e., input data (a pronunciation dictionary, a map DB, or the like) is used equivalently. For example, it can be considered that in a navigation device which carries out a voice synthesis process and a voice recognition process by using phonetic information which the phonetic information generating device generates, phonetic information of a word string having a high frequency of occurrence in a map DB is used frequently at a time of a navigation operation. Therefore, pieces of phonetic information of word strings having a high frequency of occurrence are registered in the word string information DB to prevent the phonetic information generating device from automatically generating phonetic information of a word string having a high frequency of occurrence every time when the phonetic information generating device is used, thereby reducing the time required to perform a phonetic information generating process. Further, there is a tendency for the data volume of the word string information DB 1c to increase and hence for the time required to perform a phonetic information generating process to become short with decrease in the threshold of the frequency of occurrence, while there is a tendency for the data volume of the word string information DB 1c to decrease and hence for the time required to perform a phonetic information generating process to become long with increase in the threshold of the frequency of occurrence. Therefore, the threshold can be set according to a trade-off between the data volume of the word string information DB 1c, and the time required to perform a phonetic information generating process.

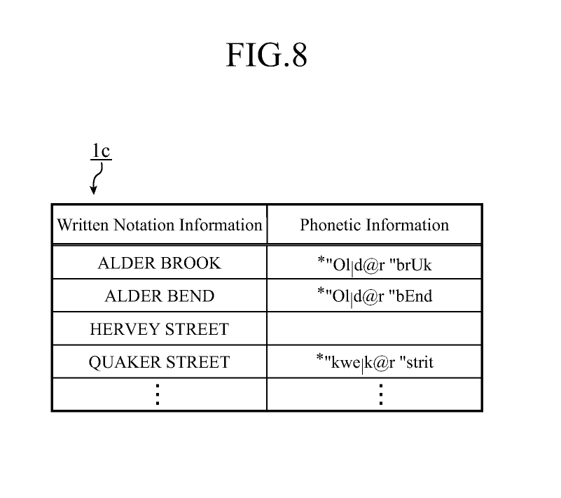

FIG. 8 is a diagram showing an example of the word string information DB 1c which the DB generating device according to this Embodiment 2 generates. Although two pieces of regular phonetic information corresponding to two pieces of written notation information “ALDER BEND” and “HERVEY STREET” are not registered in the word string information DB 1a shown in FIG. 2 because the pieces of regular phonetic information can be automatically generated from the two pieces of written notation information, respectively, the regular phonetic information corresponding to the written notation information “ALDER BEND” in the two pieces of written notation information is registered in the word string information DB 1c shown in FIG. 8 because the frequency of occurrence of the written notation information “ALDER BEND” is equal to or higher than the threshold.

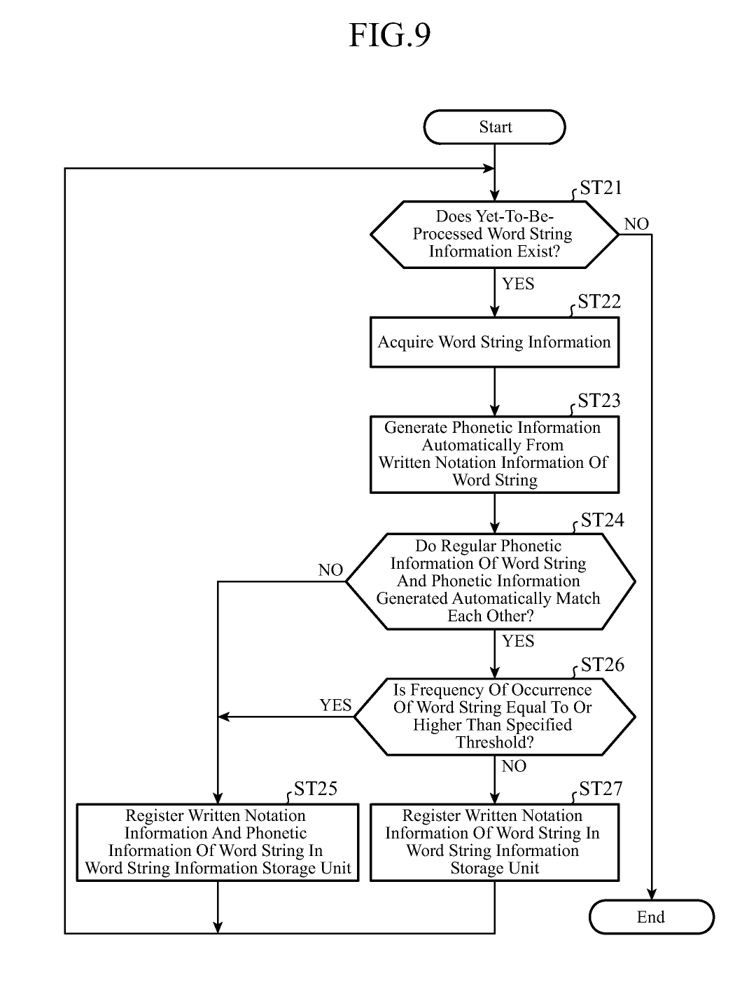

Next, the operation of the DB generating device will be explained by using a flow chart shown in FIG. 9. Because processes in steps ST21 to ST24 shown in FIG. 9 are the same as those in steps ST11 to ST14 which are explained by using FIG. 6 of above-mentioned Embodiment 1, the explanation of the processes will be omitted hereafter. When it is determined with phonetic information of a word string which is automatically generated by a phonetic information generating unit 4 does not match regular phonetic information acquired by a word string information acquiring unit 6 (when “NO” in step ST24), the word string information registering unit 8c, in next step ST25, registers the regular phonetic information acquired by the word string information acquiring unit 6 and the written notation information of the word string in the word string information DB 1c while combining the regular phonetic information and the written notation information as a set.

In contrast, when it is determined with the phonetic information automatically generated matches the regular phonetic information (when “YES” in step ST24), the frequency of occurrence calculating unit 9, in next step ST26, calculates the frequency of occurrence of the word string having the phonetic information in the input data, and outputs the frequency of occurrence to the word string information registering unit 8c, and the word string information registering unit 8c compares the frequency of occurrence with the predetermined threshold. When the frequency of occurrence is equal to or higher than the threshold (when “YES” in step ST26), the word string information registering unit 8c registers the regular phonetic information acquired by the word string information acquiring unit 6 and the written notation information in the word string information DB 1c while combining the regular phonetic information and the written notation information as a set (step ST25). In contrast, when the frequency of occurrence is lower than the threshold (when “NO” in step ST26), the word string information registering unit 8c registers only the written notation information acquired by the word string information acquiring unit 6 in the word string information DB 1c (step ST27).

In a case in which the word string information DB 1c is constructed in such a way that an ID specific to each word string and a flag showing the presence or absence of phonetic information for this word string are registered, when registering word string information of a word string in the word string information DB 1c, the word string information registering unit 8c can also register an ID specific to this word string and a flag showing the presence or absence of phonetic information (steps ST26 and ST27). Further, although the frequency of occurrence calculating unit 9 calculates the frequency of occurrence in step ST26 in the flow chart of FIG. 9, the time that the frequency of occurrence calculating unit calculates the frequency of occurrence is not limited to this example. For example, the frequency of occurrence calculating unit can calculate the frequency of occurrence of each word string in the input data before starting the process of step ST21.

As mentioned above, according to Embodiment 2, the word string information DB 1c stored in the word string information DB storage unit 1 of the phonetic information generating device is constructed in such a way that when phonetic information automatically generated from the written notation information of a word string does not match the regular phonetic information of the word string, the regular phonetic information is registered together with the written notation information, also when the phonetic information automatically generated matches the regular phonetic information while the frequency of occurrence of the word string in the word string information DB 1c is equal to or higher than a predetermined threshold, the regular phonetic information is registered together with the written notation information, and, when the phonetic information automatically generated matches the regular phonetic information while the frequency of occurrence is lower than the predetermined threshold, only the written notation information is registered. Therefore, by setting the threshold of the frequency of occurrence appropriately, both a reduction in the capacity of the database and a reduction in the time required to perform the phonetic information generating process can be achieved simultaneously.

Although the DB generating device has a structure of registering written notation information and phonetic information on a per word string basis (for each word string such as “ALDER BROOK”) in the word string information DB 1c in above-mentioned Embodiment 2, this embodiment is not limited to this structure. For example, the DB generating device has a structure of registering written notation information and phonetic information on a per word basis (for each word such as “ALDER”). The frequency of occurrence calculating unit 9 of the DB generating device can then calculate the frequency of occurrence on a per word basis, and the word string information acquiring unit 6, the phonetic information generating unit 4, the phonetic information comparing unit 7, and the word string information registering unit 8c can carry out their processes on a per word basis. Further, in a case in which the word string information DB 1c in which written notation information and phonetic information are registered on a per word basis is stored in the word string information DB storage unit 1 in the phonetic information generating device, the word string information retrieving unit 2, the phonetic information generation determining unit 3, the phonetic information generating unit 4, and the phonetic information output unit 5 have only to carry out their processes on a per word basis. Further, although a word string consisting of two words is shown in the illustrated example, a word string consisting of three or more words can be alternatively processed, or a word, instead of a word string, can be alternatively processed.

### Embodiment 3

Because a phonetic information generating device in accordance with this Embodiment 3 has substantially the same structure as the phonetic information generating device shown in FIG. 1 from a graphical viewpoint, the structure of the phonetic information generating device in accordance with this Embodiment 3 will be explained by using FIG. 1.

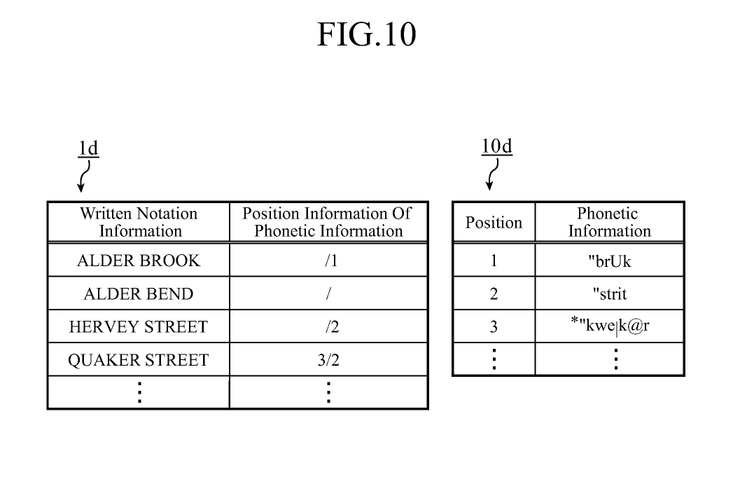

FIG. 10 is a diagram showing an example of a word string information DB 1d and a phonetic information list 10d which a word string information DB storage unit 1 stores in the phonetic information generating device according to this Embodiment 3. In the word string information DB 1d, written notation information of a word string and position information about a position where phonetic information corresponding to the written notation information is stored in a phonetic information list 10d are registered while the written notation information and the position information are being combined as a set. This position information is registered on a per word basis. Further, in the phonetic information list 10d, regular phonetic information which is acquired from a man-maintained DB, such as a pronunciation dictionary or a map DB, is registered together with position information while being combined as a set with the position information. When phonetic information automatically generated from the written notation information of a word by using G2P conversion or the like does not match the regular phonetic information of the word, the regular phonetic information of the word is registered together with the position information in the phonetic information list 10d while being combined as a set with the position information. Pieces of written notation information and pieces of position information are registered in the word string information DB 1d while each of the pieces of written notation information is being paired with position information. In contrast, when the phonetic information automatically generated from the written notation information of a word by using G2P conversion or the like matches the regular phonetic information of the word, no position information of the phonetic information is registered. A generation method of generating the word string information DB 1d and the phonetic information list 10d will be mentioned below.

For example, because a word string “ALDER BROOK” consists of words “ALDER” and “BROOK,” and phonetic information “*″Ol|d@r” automatically generated from “ALDER” matches the regular phonetic information, position information is set to “(null character string).” In contrast, because phonetic information “″krik” automatically generated from “BROOK” differs from the regular phonetic information “″brUk”, position information is set to “1.” Therefore, “(null character string)/1” is registered in the word string information DB 1d as the position information of the phonetic information corresponding to the written notation information “ALDER BROOK.” In this example, a delimiter per word for separating pieces of written notation information is “(null character string)” and a delimiter for separating pieces of position information is “/.” “1” in the word string information DB 1d is the position information of the regular phonetic information of the word “BROOK,” and “″brUk” which is the regular phonetic information of “BROOK” is registered at the position shown by the position information in the phonetic information list 10d.

For example, because regular phonetic information can be acquired for each of the words “ALDER” and “BEND” in the word string “ALDER BEND” through the automatic generation, nothing (i.e., “(null character string)/(null character string)”) is registered as the position information of the phonetic information which is combined as a set with the written notation information “ALDER BEND.”

Further, because while regular phonetic information of “HERVEY” in the word string “HERVEY STREET” can be acquired through the automatic generation, regular phonetic information of “STREET” cannot be acquired through the automatic generation, only the position information of the phonetic information corresponding to the written notation information “STREET” is registered. Therefore, “(null character string)/2” is registered in the word string information DB 1d as the position information. The regular phonetic information “″strit” corresponding to the written notation information “STREET” is registered at the position of “2” in the phonetic information list 10d. In contrast, because no regular phonetic information can be acquired for each of the words “QUAKER” and “STREET” in the word string “QUAKER STREET” through the automatic generation, the position information of each of the pieces of phonetic information is registered. However, because the regular phonetic information “″strit” corresponding to “STREET” is registered at the position of “2” in the phonetic information list 10d, “ 3/2” is registered in the word string information DB 1d as the pieces of position information. In the other phonetic information list 10d, the regular phonetic information “*″kwe|k@r” corresponding to the written notation information “QUAKER” is registered at the position of “3.” Therefore, because no regular phonetic information is registered duplicately for an identical written notation, such as “STREET,” in the phonetic information list 10d, the capacity of the word string information DB storage unit 1 for storing the phonetic information list 10d can be reduced. For convenience of explanation, whether regular phonetic information can be automatically generated by using G2P conversion or the like is determined presumptively for each word string shown above as an example, it is needless to say that there is a case in which phonetic information automatically generated from written notation information differs from phonetic information automatically generated by using actual G2P conversion.

In the phonetic information generating device in accordance with this Embodiment 3, a phonetic information output unit 5 can refer to the phonetic information list 10d of the word string information DB storage unit 1, unlike in the case shown in FIG. 1 of above-mentioned Embodiment 1.

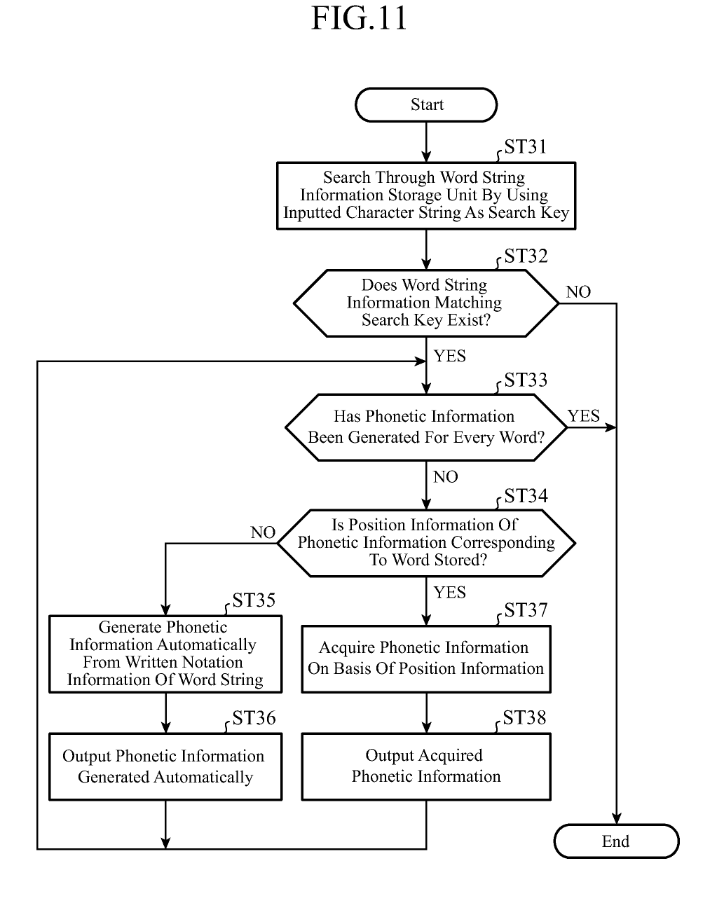

Next, the operation of the phonetic information generating device using the word string information DB 1d and the phonetic information list 10d will be explained by using a flow chart shown in FIG. 11. Because processes in steps ST31 and ST32 shown in FIG. 11 are the same as those in steps ST1 and ST2 which are explained by using FIG. 4 of above-mentioned Embodiment 1, the explanation of the processes will be omitted hereafter. When no word string information matching a search key exists in the word string information DB 1d that stores the word string information DB storage unit 1 (when “NO” in step ST32), the phonetic information generating device ends a series of phonetic information generating processes. At that time, a certain unit, e.g., the phonetic information output unit 5 can produce an external output showing that the word string is not registered in the word string information DB 1d.

In contrast, when word string information matching the search key exists in the word string information DB 1d (when “YES” in step ST32), a word string information retrieving unit 2 retrieves the word string information matching the search key and including written notation information and the position information of phonetic information from the word string information DB 1d, and outputs the word string information to a phonetic information generation determining unit 3. For example, in a case in which the word string information DB storage unit 1 has a structure of storing the word string information DB 1d and the phonetic information list 10d as shown in FIG. 10, when an input character string “ALDER BROOK” is inputted, the word string information retrieving unit 2 uses this input character string as a search key for written notation information and retrieves the word string information including the written notation information “ALDER BROOK” and the position information “(null character string)/1” of the phonetic information which is combined as a set with the written notation information from the word string information DB 1d.

The phonetic information generating device, in next steps ST33 to ST38, generates phonetic information for each of the words which construct the word string which the word string information retrieving unit 2 retrieves and outputs the phonetic information to outside the phonetic information generating device. The phonetic information generation determining unit 3, in step ST33, checks whether phonetic information exists for every of all the words which construct the word string information inputted thereto from the word string information retrieving unit 2 first, and, when phonetic information exists for every of all the words or when completing the generation of phonetic information for every of all the words (when “YES” in step ST33), determines that the phonetic information generation determining unit does not have to generate phonetic information any longer, and ends the series of phonetic information generating processes, otherwise (when “NO” in step ST33), determines whether or not it is necessary to generate phonetic information for each of the words sequentially from the first word in the word string (step ST34). More specifically, the phonetic information generation determining unit checks to see whether or not position information corresponding to the written notation information of the word which is the target for processing is included in the word string information.

When no position information corresponding to the written notation information of the word which is the target for processing is included in the word string information, the phonetic information generation determining unit 3 determines that it is necessary to automatically generate phonetic information for the word (when “NO” in step ST34), and outputs the written notation information of the word to a phonetic information generating unit 4. The phonetic information generating unit 4, in next step ST35, generates phonetic information from the written notation information inputted thereto from the phonetic information generation determining unit 3 by using G2P conversion or the like, and outputs the phonetic information to the phonetic information output unit 5. Then, the phonetic information output unit 5, in next step ST36, outputs the phonetic information automatically generated by the phonetic information generating unit 4 to outside the phonetic information generating device. In the example of above-mentioned “ALDER BROOK,” the first-time performance of the processes of steps ST33 to ST38, which are repeatedly performed, results in the position information of the phonetic information corresponding to the written notation information “ALDER” of the first word being determined as “(null character string),” and this means that no regular phonetic information of the word is registered in the phonetic information list 10d. As a result, the phonetic information generating unit 4 automatically generates the same phonetic information “*″Ol|d@r” as the regular phonetic information from the written notation information “ALDER,” and the phonetic information output unit 5 outputs the phonetic information to outside the phonetic information generating device.

In contrast, when position information corresponding to the written notation information of the word which is the target for processing is included in the word string information, the phonetic information generation determining unit 3 determines that it is unnecessary to automatically generate phonetic information for the word (when “YES” in step ST34), and outputs the position information of the phonetic information of the word to the phonetic information output unit 5. On the basis of the position information of the phonetic information inputted from the phonetic information generation determining unit 3, the phonetic information output unit 5, in next step ST37, acquires the phonetic information registered at the position from the phonetic information list 10d of the word string information DB storage unit 1. Then, the phonetic information output unit 5, in next step ST38, outputs the phonetic information acquired from the phonetic information list 10d to outside the phonetic information generating device. In the example of above-mentioned “ALDER BROOK,” the second-time performance of the processes of steps ST33 to ST38, which are repeatedly performed, results in the position information of the phonetic information corresponding to the written notation information “BROOK” of the second word being determined as “1,” and this means that the regular phonetic information “″brUk” is registered at the position “1” of the phonetic information list 10d. As a result, the phonetic information output unit 5 acquires the phonetic information “″brUk” from the phonetic information list 10d and outputs the phonetic information to outside the phonetic information generating device.

After completing the processes in up to step ST36 or ST38, the phonetic information generating device returns to step ST33 again and starts the processing on the next word included in the word string information. Thus, the phonetic information generating device outputs the phonetic information of each of the words in the word string corresponding to the input character string in order starting with the first word of the word string. Instead of outputting the phonetic information to outside on a per word basis, the phonetic information generating device can output the phonetic information to outside on a per word basis. In that case, the phonetic information output unit 5 can combine the phonetic information of each of the words inputted from the phonetic information generation determining unit 3 and the phonetic information of the word inputted from the phonetic information generating unit 4 in order in which the word is inputted thereto to generate phonetic information of the word string.

Further, although the phonetic information generating device is constructed in such a way that the word string information retrieving unit 2 retrieves written notation information and the position information of phonetic information from the word string information DB 1d, and notifies the position information to the phonetic information output unit 5, and the phonetic information output unit 5 acquires the phonetic information corresponding to the position information from the phonetic information list 10d, as shown in the flow chart of FIG. 11, the structure of the phonetic information generating device is not limited to this example. For example, the phonetic information generating device can be constructed in such a way that the word string information retrieving unit 2 retrieves written notation information and the position information of phonetic information from the word string information DB 1d, and also retrieves the phonetic information corresponding to the position information from the phonetic information list 10d, and the phonetic information generating unit 4 receives the phonetic information from the word string information retrieving unit 2 via the phonetic information generation determining unit 3.

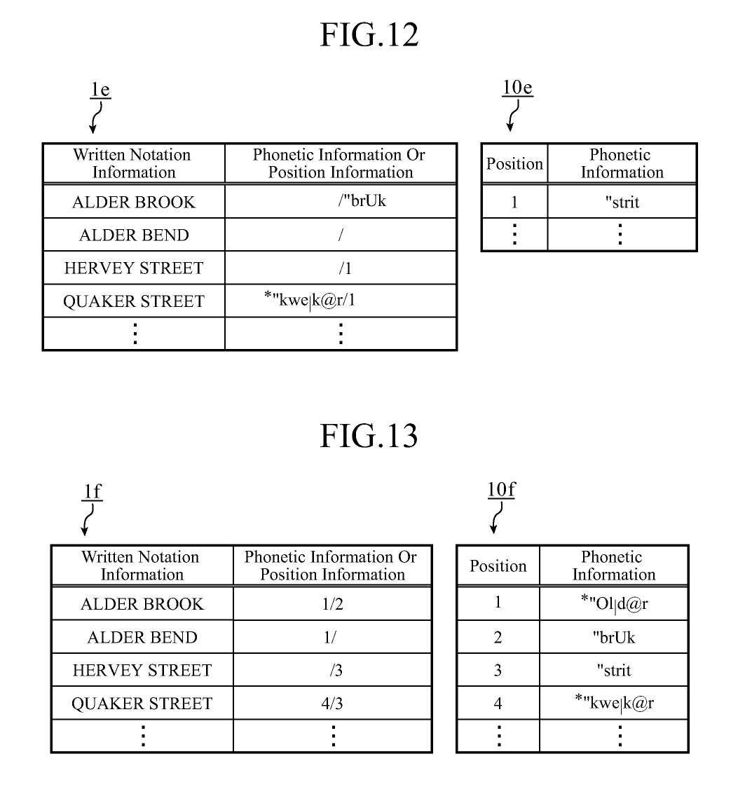

Further, the word string information DB storage unit 1 can store a word string information DB 1e and a phonetic information list 10e which are shown in FIG. 12, instead of the word string information DB 1d and the phonetic information list 10d which are shown in FIG. 10. As shown in FIG. 12, only the regular phonetic information of a word (e.g., “STREET”) which appears duplicately in each of word strings is registered in the phonetic information list 10e. The position information (e.g., “1”) of phonetic information of a word (e.g., “STREET”) which appears duplicately in each of word strings is then registered in the word string information DB 1e together with the written notation information of the word which is combined as a set with the position information while the regular phonetic information (e.g., “″brUk”) of a word (e.g., “BROOK”) which does not appear duplicatedly in word strings is registered directly in the word string information DB 1e together with the written notation information of the word which is combined as a set with the regular phonetic information, and no phonetic information (i.e., “(null character string)”) is registered in the word string information DB 1e for the written notation information of a word (e.g., “ALDER”) which does not appear duplicatedly in word strings and for which the same phonetic information as the regular phonetic information can be automatically generated by using G2P conversion or the like.

Next, the operation of a DB generating device will be explained. Because the DB generating device in accordance with this Embodiment 3 has substantially the same structure as the DB generating device shown in FIG. 5 from a graphical viewpoint, except for the word string information DB 1a, the structure of the DB generating device in accordance with this Embodiment 3 will be explained by using FIG. 5. The DB generating device in accordance with this Embodiment 3 generates the word string information DB 1d and the phonetic information list 10d, instead of the word string information DB 1a. This DB generating device operates in substantially the same way as that shown in the flow chart shown in FIG. 6 of above-mentioned Embodiment 1. However, while the DB generating device according to above-mentioned Embodiment 1 carries out the generation of phonetic information and the registration of the phonetic information in the DB on a per word string basis, the DB generating device according to this Embodiment 3 carries out the generation of phonetic information and the registration of the phonetic information in the DB on a per word basis. Further, for a word for which the phonetic information generating unit cannot automatically generate regular phonetic information, a word string information registering unit 8, in step ST16 of FIG. 6, registers the regular phonetic information which the word string information registering unit acquires from the input data in the phonetic information list 10d, and also registers the written notation information of the word and the position information of the phonetic information in the word string information DB 1d. On the other hand, in the case of generating the word string information DB 1e and the phonetic information list 10e which are shown in FIG. 12, when registering phonetic information in the phonetic information list 10e in step ST16, the word string information registering unit 8 checks whether or not the same phonetic information has been registered, and registers the position information of the phonetic information in the word string information DB 1e when the same phonetic information has been registered. When the same phonetic information has not been registered in the phonetic information list 10e, the word string information registering unit registers the regular phonetic information of the word in the phonetic information list 10e, and also registers the written notation information and the position information in the word string information DB 1e.

As mentioned above, the phonetic information generating device according to Embodiment 3 is constructed in such a way that the word string information DB storage unit 1 of the phonetic information generating device has the phonetic information list 10d in which for a word for which phonetic information automatically generated from its written notation information does not match regular phonetic information, this regular phonetic information is registered, and in the word string information DB 1d, position information showing the registration position of the regular phonetic information in the phonetic information list 10d is registered, instead of the regular phonetic information, together with the written notation information, and in such a way that the word string information retrieving unit 2 retrieves the notation information matching the input character string from the word string information DB 1d, the phonetic information generation determining unit 3 determines whether the position information corresponding to the written notation information which the word string information retrieving unit 2 retrieves is registered in the word string information DB 1d, the phonetic information generating unit 4 generates phonetic information from the written notation information for which no position information is registered according to the result of the determination by the phonetic information generation determining unit 3 by using a predetermined method, such as G2P conversion, and the phonetic information output unit 5 outputs the phonetic information which the phonetic information generating unit 4 generates when no position information corresponding to the written notation information is registered according to the result of the determination by the phonetic information generation determining unit 3, or outputs the regular phonetic information registered at the position shown by the position information in the phonetic information list 10d when the position information corresponding to the written notation information is registered. Therefore, the phonetic information generating device can prevent the same phonetic information from being duplicately registered in the phonetic information list 10d two or more times, thereby being able to reduce the amount of information stored in the word string information DB storage unit 1.

Although the DB generating device has a structure of registering written notation information and the position information of phonetic information on a per word basis (for each word such as “ALDER”) in the word string information DB 1d or 1e in above-mentioned Embodiment 3, this embodiment is not limited to this structure. For example, the DB generating device has a structure of registering written notation information and the position information of phonetic information on a per word string basis (for each word string such as “ALDER BROOK”). Further, in a case in which the word string information DB 1d or 1e in which written notation information and the position information of phonetic information are registered on a per word basis is stored in the word string information DB storage unit 1 in the phonetic information generating device, the word string information retrieving unit 2, the phonetic information generation determining unit 3, the phonetic information generating unit 4, and the phonetic information output unit 5 have only to carry out their processes on a per word basis. Further, although a word string consisting of two words is shown in the illustrated example, a word string consisting of three or more words can be alternatively processed, or a word, instead of a word string, can be alternatively processed.

In addition, in a case in which a word string, such as “ALDER BROOK ROAD” or “ALDER BROOK PARK,” can be assumed to be a combination of a word string such as “ALDER BROOK” and a word such as “ROAD (or PARK)”, the word string and the word can be registered in the word string information DB 1d or 1e in such a way that the word string and the word coexist in this DB. In this case, a delimiter for separating words (e.g., “(null character string)”) and a delimiter (e.g., “/”) showing a separator for separating registration units are defined for both the input data inputted to the DB generating device and the input character string inputted to the phonetic information generating device. Then, in each of the devices, a word string, such as “ALDER BROOK/ROAD”, can be divided into a word string and a word according to the delimiters, and the processing can be carried out on each of the divided parts. On the other hand, there is a case in which even if two or more types of delimiters can be pre-defined for the input data inputted to the DB generating device, two or more types of delimiters cannot be pre-defined for the input character string inputted to the phonetic information generating device. In that case, the DB generating device has only to generate a word string information DB 1d or 1e in a state in which word strings and words coexist according to the two or more types of delimiters, as mentioned above. On the other hand, in the phonetic information generating device, the word string information retrieving unit 2 retrieves, for example, “ALDER BROOK ROAD” from the word string information DB 1d or 1e according to only the delimiter for separating words (e.g., “(null character string)”), and, when “ALDER BROOK ROAD” is not registered, divides “ALDER BROOK ROAD” into “ALDER BROOK” and “ROAD” and then retrieves “ALDER BROOK” and “ROAD.” Even when determining that “ALDER BROOK” and “ROAD” are not registered through this retrieving process, the word string information retrieving unit uses a method of dividing one word string into a plurality of parts by using a plurality of delimiter positions to, for example, change the delimiter positions and divide the word string into “ALDER” and “BROOK ROAD”, and then retrieves “ALDER” and “BROOK ROAD.”

### Embodiment 4

Because a DB generating device in accordance with this Embodiment 4 has substantially the same structure as the DB generating device shown in FIG. 7 from a graphical viewpoint, except for a word string information DB 1c, the structure of the DB generating device in accordance with this Embodiment 4 will be explained by using FIG. 7. The DB generating device in accordance with this Embodiment 4 generates a word string information DB 1f and a phonetic information list 10f which are shown in FIG. 13, instead of the word string information DB 1c. Further, because a phonetic information generating device that uses the word string information DB 1f and the phonetic information list 10f which the DB generating device in accordance with this Embodiment 4 generates has the same structure as the phonetic information generating device shown in FIG. 1, the structure of the phonetic information generating device is as shown in FIG. 1.

In above-mentioned Embodiment 3, when the phonetic information automatically generated by the phonetic information generating unit 4 matches the regular phonetic information, the phonetic information generating device does not register the regular phonetic information in the word string information DB 1d or 1e. In contrast, even though phonetic information of a word which is automatically generated by a phonetic information generating unit matches the regular phonetic information of the word, the phonetic information generating device in accordance with this Embodiment 4 registers the regular phonetic information in a word string information DB 1f when the frequency of occurrence of the word is equal to or higher a specified threshold.

FIG. 13 is a diagram showing an example of the word string information DB 1f and the phonetic information list 10f which the DB generating device in accordance with this Embodiment 4 generates. Because while the phonetic information generating device can automatically generate the regular phonetic information for the written notation information “ALDER”, the frequency of occurrence of this word which the frequency of occurrence calculating unit 9 calculates is equal to or higher than the predetermined threshold, the position information “1” of the phonetic information is registered in the word string information DB 1f shown in FIG. 13. The regular phonetic information “*″Ol|d@r” is registered at the position of “1” in the phonetic information list 10f. In contrast with this, in the phonetic information generating device above-mentioned Embodiment 3, the position information of the phonetic information corresponding to the written notation information “ALDER” is not registered in the word string information DB 1d shown in FIG. 10. Because the frequency of occurrence of any other word in this example is less than the threshold even though regular phonetic information can be automatically generated, the word string information DB does not differ from the word string information DB 1d shown in FIG. 10, with the exception that because “*″Ol|d@r” is registered at the position of “1” in the phonetic information list 10f, each of the subsequent pieces of phonetic information is shifted by one position.

Next, the operation of the DB generating device will be explained. This DB generating device operates in substantially the same way as that shown in the flow chart shown in FIG. 9 of above-mentioned Embodiment 2. Although the DB generating device in accordance with above-mentioned Embodiment 2 carries out the generation of phonetic information and the registration of the phonetic information in the DB on a per word string basis, the DB generating device according to this Embodiment 4 carries out the generation of phonetic information and the registration of the phonetic information in the DB on a per word basis. Further, for a word for which no regular phonetic information can be automatically generated and for a word for which regular phonetic information can be automatically generated while the frequency of occurrence of the word is equal to or higher than the threshold, a word string information registering unit 8c, in step ST25 of FIG. 9, registers the regular phonetic information which the word string information registering unit acquires from input data in the phonetic information list 10f, and also registers the written notation information of the word and the position information of phonetic information in the word string information DB 1f.

As mentioned above, the phonetic information generating device according to Embodiment 4 is constructed in such a way that the word string information DB storage unit 1 of the phonetic information generating device has the phonetic information list 10f in which for a word for which phonetic information automatically generated from its written notation information does not match regular phonetic information, this regular phonetic information is registered, and in the word string information DB 1f, when phonetic information automatically generated from the written notation information of a word does not match the regular phonetic information of the word, the position information showing the registration position of the regular phonetic information in the phonetic information list 10f is registered together with the written notation information, also when the phonetic information automatically generated matches the regular phonetic information while the frequency of occurrence of the word in the word string information DB 1f is equal to or higher than the predetermined threshold, the position information is registered together with the written notation information, and, when the phonetic information automatically generated matches the regular phonetic information while the frequency of occurrence is lower than the predetermined threshold, only the written notation information is registered. Therefore, the phonetic information generating device can prevent the same phonetic information from being duplicately registered in the phonetic information list 10f two or more times, thereby being able to reduce the amount of information stored in the word string information DB storage unit 1, like that according to above-mentioned Embodiment 3. Further, by setting the threshold of the frequency of occurrence appropriately, both a reduction in the amount of information stored in the word string information DB storage unit 1 and a reduction in the time required to perform the phonetic information generating process can be achieved simultaneously, like in the case of above-mentioned Embodiment 2.

Although the DB generating device has a structure of registering written notation information and the position information of phonetic information on a per word basis (for each word such as “ALDER”) in the word string information DB if in above-mentioned Embodiment 4, this embodiment is not limited to this structure. For example, the DB generating device has a structure of registering written notation information and the position information of phonetic information on a per word string basis (for each word string such as “ALDER BROOK”). The frequency of occurrence calculating unit 9 of the DB generating device can then calculate the frequency of occurrence on a per word basis, and the word string information acquiring unit 6, the phonetic information generating unit 4, the phonetic information comparing unit 7, and the word string information registering unit 8c can carry out their processes on a per word string basis. Further, in a case in which the word string information DB 1f in which written notation information and phonetic information are registered on a per word string basis is stored in the word string information DB storage unit 1 in the phonetic information generating device, the word string information retrieving unit 2, the phonetic information generation determining unit 3, the phonetic information generating unit 4, and the phonetic information output unit 5 have only to carry out their processes on a per word string basis. Further, although a word string consisting of two words is shown in the illustrated example, a word string consisting of three or more words can be alternatively processed, or a word, instead of a word string, can be alternatively processed. In addition, for each word string information in which a word string and a word coexist, such as “ALDER BROOK ROAD” and “ALDER BROOK PARK”, the word string and the word can be registered in the word string information DB 1f in such a way that the word string and the word coexist in this DB, like in the case explained in above-mentioned Embodiment 3.

### Embodiment 5

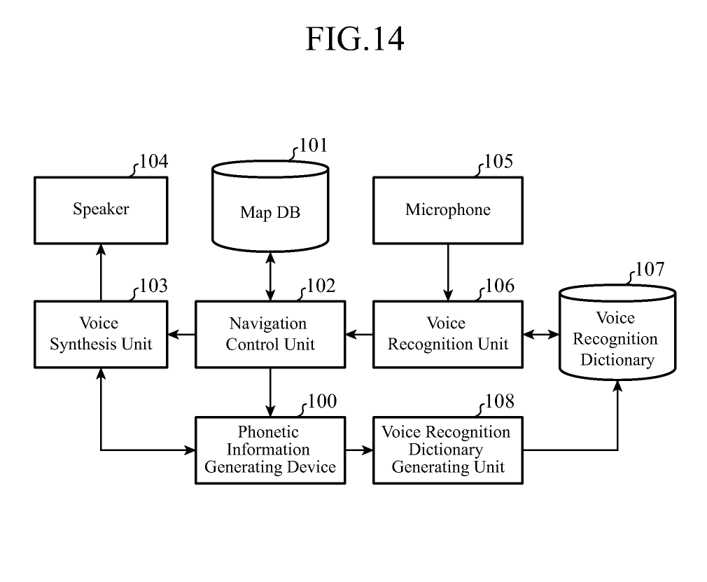

FIG. 14 is a block diagram showing the structure of a navigation device in accordance with this Embodiment 5. This navigation device is provided with a phonetic information generating device 100 for generating phonetic information used for voice synthesis and voice recognition, a map DB 101 for storing map information including place names, road names, facility names, etc., and their positions, a navigation control unit 102 for carrying out a route search, route guidance, etc. by using map information, a voice synthesis unit 103 for synthesizing a voice with which the navigation device carries out route guidance or the like, a speaker 104 for outputting the synthesized voice, a microphone 105 for collecting a user's utterance, a voice recognition unit 106 for carrying out voice recognition on the user's utterance, such as a destination uttered by the user, by using a voice recognition dictionary 107, and a voice recognition dictionary generating unit 108 for generating the voice recognition dictionary 107 from the phonetic information generated by the phonetic information generating device 100.

The phonetic information generating device 100 is the one explained in any one of above-mentioned Embodiments 1 to 4. Hereafter, the phonetic information generating device 100 will be explained by taking the phonetic information generating device in accordance with Embodiment 1 as an example, and the structure of the phonetic information generating device 100 is as shown in FIG. 1. A word string information DB storage unit 1 of the phonetic information generating device 100 stores a word string information DB generated from word strings or words, such as place names and facility names, which are stored in the map DB 101. The voice recognition dictionary generating unit 108 generates a voice recognition dictionary 107 for voice recognition by using phonetic information which the phonetic information generating device 100 outputs. Because a known technique can be used as a method of generating the voice recognition dictionary from the phonetic information, the explanation of the method of generating the voice recognition dictionary will be omitted hereafter.

When the navigation device performs a search for a route, for example, the navigation control unit 102 retrieves facility names each of which is a retrieval target when retrieving facilities in the surroundings of a certain point (facilities or the like in the surroundings of a current position or a destination) from the map DB 101, and outputs the facility names to the phonetic information generating device 100. The phonetic information generating device 100 generates phonetic information corresponding to the word string or word of the facility name inputted thereto, and outputs the phonetic information to the voice recognition dictionary generating unit 108. The voice recognition dictionary generating unit 108 generates a voice recognition dictionary 107 by using the word string or word inputted thereto. As an alternative, when retrieving the names of roads included in a city, the navigation control unit 102 can retrieve the road names each of which is a retrieval target (the names of roads passing through the selected city) from the map DB 101, and output the road names to the phonetic information generating device 100, and the voice recognition dictionary generating unit can also generate a voice recognition dictionary 107 of the road names in the same way that the voice recognition dictionary generating unit generates a voice recognition dictionary by using the word strings or words of the above-mentioned facility names.

The navigation control unit 102 then produces a screen display of the facility names each of which is a retrieval target, and causes the user to utter a facility name showing his or her desired destination and collects the user's utterance by using the microphone 105, and the voice recognition unit 106 carries out voice recognition on the user's utterance by using the voice recognition dictionary 107, and sends the result of the voice recognition back to the navigation control unit 102. Next, in order to check whether the voice recognition unit has correctly carried out voice recognition on the destination uttered by the user, the navigation control unit 102 outputs the character string which is the result of the voice recognition showing the destination inputted from the voice recognition unit 106 (or a specific ID set to the character string) to the voice synthesis unit 103, and the voice synthesis unit 103 outputs the character string (or ID) of the destination to the phonetic information generating device 100. The phonetic information generating device 100 generates phonetic information corresponding to the word string or word of the destination, and outputs the phonetic information to the voice synthesis unit 103. The voice synthesis unit 103 then synthesizes voice information corresponding to the phonetic information, and outputs the voice information from the speaker 104.

Further, when carrying out route guidance, for example, the navigation control unit 10 outputs a character string (or ID) used for guidance, such as a place name, a facility name, or a road name, to the voice synthesis unit 103, and the voice synthesis unit 103 acquires phonetic information corresponding to the character string (or ID) from the phonetic information generating device 100 and synthesizes voice information, and outputs the voice information from the speaker 104.

The phonetic information generating device 100 can be applied to not only the navigation device shown in FIG. 14, but also to, for example, an audio device. In the case in which the phonetic information generating device is applied to an audio device, the audio device has an audio control unit for playing a CD instead of the navigation control unit 102. When a medium is inserted into the audio device, for example, the audio device receives bibliographic data (e.g., a song title, an artist name, or the like) as its input character string, and the phonetic information generating device 100 and the voice recognition dictionary generating unit 108 work in cooperation with each other to generate a voice recognition dictionary 107 used for voice recognition of an artist name, a song title, or the like. Further, when a user makes a search, for example, the audio device can receive a search result (e.g., an album title which is extracted by setting an artist name as a search key) as its input character string, and generate a voice recognition dictionary 107 used for voice recognition of album titles. Next, the voice recognition unit 106 carries out voice recognition on a song title, an artist name, an album title, or the like uttered by a user, the audio control unit plays a musical piece according to the result of the recognition, and the voice synthesis unit 103 generates a synthesized voice from the bibliographic data of the musical piece to notify this bibliographic data to the user. Further, the above-mentioned navigation device can be of audio integrated type. Further, a device to which the phonetic information generating device is applied can include functions for telephone of performing a handsfree phone call and so on. In this case, when the telephone is connected to a head unit, the device extracts the name of each entry (a person's name or a facility name, such as a restaurant name) in a telephone directory from a dictionary for telephone directory search, and generates a voice recognition dictionary by using the phonetic information generating device 100. The device can carry out voice recognition on the user's utterance to determine the calling destination, and start a phone call.

As mentioned above, because the phonetic information generating device in accordance with any one of above-mentioned Embodiments 1 to 4 can be downsized according to a reduction in the database size, the phonetic information generating device is suitable for use in a vehicle-mounted information device that is requested of downsizing, such as a car navigation device or a car audio device. Further, although the size of the storage unit increases in a case of using a voice recognition dictionary generated offline in advance, the size of the storage unit used for voice recognition dictionaries can be reduced in accordance with this Embodiment 5 because a voice recognition dictionary is generated online by using the phonetic information generating device 100. The navigation device is not limited to the one for vehicles, but can be a navigation device for moving objects including one for persons, one for rail cars, one for ships, and one for airplanes. For example, the navigation device is the one suitable for being used while being carried onto or mounted to a vehicle.

Further, although above-mentioned Embodiments 1 to 5 are explained by taking an English word string as an example, the present invention is not limited to this example. It is needless to say that the present invention can be applied to an arbitrary language, such as Japanese, Chinese, or German. Further, a method of expressing phonetic information in a written form is not limited to the illustrated example, and the international phonetic symbol (IPA) or the like can be used to express phonetic information in a written form.

In addition, while the invention has been described in its preferred embodiments, it is to be understood that an arbitrary combination of two or more of the embodiments can be made, various changes can be made in an arbitrary component in accordance with any one of the embodiments, and an arbitrary component in accordance with any one of the embodiments can be omitted within the scope of the invention.

### INDUSTRIAL APPLICABILITY

As mentioned above, because the phonetic information generating device in accordance with the present invention generates correct phonetic information by using a database having a small capacity, the phonetic information generating device is suitable for use in a vehicle-mounted information device, such as a car navigation device or a car audio device.

### EXPLANATIONS OF REFERENCE NUMERALS

1 word string information DB storage unit, 1a to 1f word string information DB (word string/word information database), 2 word string information retrieving unit, 3 phonetic information generation determining unit, 4 phonetic information generating unit, 5 phonetic information output unit, word string information acquiring unit, 7 phonetic information comparing unit, 8 and 8c word string information registering unit, 9 frequency of occurrence calculating unit, 10d to 10f phonetic information list, 100 phonetic information generating device, 101 map DB, 102 navigation control unit, 103 voice synthesis unit, 104 speaker, 105 microphone, 106 voice recognition unit, 107 voice recognition dictionary, 108 voice recognition dictionary generating unit.

1. A phonetic information generating device comprising:
a word string/word information database in which when phonetic information automatically generated from written notation information of a word string or a word does not match regular phonetic information corresponding to the written notation of said word string or said word, said regular phonetic information is registered together with said written notation information, or, when the phonetic information automatically generated matches the regular phonetic information, said written notation information is registered, but said regular phonetic information is not registered;
a word string information retriever that retrieves written notation information corresponding to an inputted word string or word from said word string/word information database;
a phonetic information generation determinator that determines whether or not regular phonetic information corresponding to said written notation information which said word string information retriever retrieves is registered in said word string/word information database;
a phonetic information generator that generates phonetic information from said written notation information for which no regular phonetic information is registered according to a result of the determination by said phonetic information generation determinator; and
a phonetic information output unit that, when regular phonetic information corresponding to said written notation information is not registered according to the result of the determination by said phonetic information generation determinator, outputs said phonetic information generated by said phonetic information generator, or, when the regular phonetic information is registered, outputs said regular phonetic information registered in said word string/word information database.

2. The phonetic information generating device according to claim 1, wherein in the word string/word information database, when the phonetic information automatically generated from the written notation information of the word string or the word does not match the regular phonetic information of said word string or said word, said regular phonetic information is registered together with said written notation information, also when the phonetic information automatically generated matches the regular phonetic information while a frequency of occurrence of said word string or said word in said word string/word information database is equal to or higher than a predetermined threshold, said regular phonetic information is registered together with said written notation information, and, when the phonetic information automatically generated matches the regular phonetic information while said frequency of occurrence is lower than the predetermined threshold, said written notation information is registered, but said regular phonetic information is not registered.

3. The phonetic information generating device according to claim 1, wherein said phonetic information generating device has a phonetic information list in which for a word string or a word for which phonetic information automatically generated from its written notation information does not match regular phonetic information, said regular phonetic information is registered, and wherein in the word string/word information database, position information showing a registration position of said regular phonetic information in said phonetic information list is registered, instead of said regular phonetic information, together with said written notation information, the phonetic information generation determinator determines whether position information corresponding to the written notation information which the word string information retriever retrieves is registered in said word string/word information database, said phonetic information generator generates phonetic information from said written notation information for which no position information is registered according to a result of the determination by said phonetic information generation determinator, the phonetic information output unit outputs said phonetic information which said phonetic information generator generates when no position information corresponding to said written notation information is registered according to the result of the determination by said phonetic information generation determinator, or outputs the regular phonetic information registered at the position shown by said position information in said phonetic information list when the position information corresponding to said written notation information is registered.

4. The phonetic information generating device according to claim 3, wherein in the word string/word information database, when the phonetic information automatically generated from the written notation information of the word string or the word does not match the regular phonetic information of said word string or said word, the position information showing the registration position of said regular phonetic information in the phonetic information list is registered together with said written notation information, also when the phonetic information automatically generated matches the regular phonetic information while a frequency of occurrence of said word string or said word in said word string/word information database is equal to or higher than a predetermined threshold, said position information is registered together with said written notation information, and, when the phonetic information automatically generated matches the regular phonetic information while said frequency of occurrence is lower than the predetermined threshold, said written notation information is registered, but said regular phonetic information is not registered.

5. A vehicle-mounted information device comprising:
a phonetic information generating device according to claim 1; and
at least one of a voice synthesizer that generates phonetic information of a word string or a word whose sound is to be outputted by using said phonetic information generating device, and for converting said generated phonetic information into a synthesized voice, and a voice recognizer that generates a voice recognition dictionary on a basis of phonetic information which said phonetic information generating device generates from an input character string including a word string or a word which is a target for voice recognition, and for carrying out voice recognition on voice information inputted thereto by using said voice recognition dictionary.

6. A database generation method comprising:
a phonetic information generating step of generating phonetic information from written notation information of a word string or a word on a basis of input data including said written notation information and regular phonetic information corresponding to the written notation of said word string or said word;
a phonetic information comparing step of comparing the phonetic information generated in said phonetic information generating step with said regular phonetic information included in said input data; and
a word string information registering step of registering said regular phonetic information in a database together with said written notation information when the phonetic information generated in said phonetic information generating step does not match said regular phonetic information according to a result of the comparison in said phonetic information comparing step, or, when the phonetic information generated matches said regular phonetic information, registering said written notation information in said database, but not registering said regular phonetic information.
